(19) United States
(12) Patent Application Publication
(10) Pub. No.: US 2014/0362049 A1
(43) Pub. Date: Dec. 11, 2014

(54) INPUT DEVICE

(71) Applicant: Panasonic Corporation, Osaka (JP)

(72) Inventor: Manabu INOUE, Osaka (JP)

(21) Appl. No.: 14/465,298

(22) Filed: Aug. 21, 2014

Related U.S. Application Data
(63) Continuation of application No. PCT/JP2013/000839, filed on Feb. 15, 2013.

(30) Foreign Application Priority Data
Feb. 24, 2012 (JP) 2012-038448

(51) Int. Cl. G06F 3/044

(52) U.S. Cl. CPC G06F 3/044
USPC 345/174

(57) ABSTRACT

A capacitance coupling type input device that can be manufactured easily is provided. The input device is arranged at the observer side of a display apparatus and provided with a pair of electrodes for detecting coordinates 18, 19 facing each other to cross at right angles via a dielectric element. The display apparatus has a translucent substrate 16 on a front substrate 12 arranged at the observer side of a display panel. An electrode 18 as one of the electrodes for detecting coordinates is formed on the surface of the translucent substrate 16 at the display panel side. An electrodes 19 as the other electrode for detecting coordinates is formed on the front substrate 12 of the display panel. And the translucent substrate 16 is bonded onto the front substrate 12 of the display panel 2 via an adhesive 17 serving as the dielectric element.

### TECHNICAL FIELD

The present disclosure relates to an input device for performing an input operation by touching a display screen. In particular, the present disclosure relates to a capacitance coupling type input device for detecting a touch position with an electrode arranged via a dielectric element.

### BACKGROUND ART

A display apparatus including an input device having a screen input function of inputting information through a touch operation by a user's finger or the like with respect to a display screen has been used in mobile electronic equipment such as a PDA and a portable terminal, various household electrical products, and stationary customer guidance terminals such as an unattended reception machine. As the above-mentioned input device involving a touch operation, various systems have been known, such as a resistive film system that detects a change in the resistance value of a touched portion, a capacitance coupling system of detecting a change in capacitance caused by a touch operation, and an optical sensor system of detecting a change in light amount in a portion shielded due to a touch operation.

Of these various input systems, the capacitance coupling system has the following advantages, compared with the resistive film system and the optical sensor system. For example, the transmittance of an input device is as low as about 80% in the resistive film system and in the optical sensor system, whereas the transmittance of an input device is as high as about 90% and image quality of a display image is not degraded in the capacitance coupling system. Further, the resistive film system has a risk in that a resistive film may be degraded or damaged because a touch position is detected by the mechanical contact of the resistive film, whereas the capacitance coupling system involves no mechanical contact such as contact of a detection electrode with another electrode, and hence is advantageous also from the viewpoint of durability.

As a capacitance coupling type input device, for example, there is given a system as disclosed by Patent Document 1.

### PRIOR ART DOCUMENTS

### Patent Documents

Patent Document 1: JP 2011-90458 A

### DISCLOSURE OF INVENTION

### Problem to be Solved by the Invention

An object of the present invention is to provide an input device of a capacitance coupling system that is advantageous to a resistive film system or an optical sensor system. And, the input device can be manufactured easily.

### Means for Solving Problem

For achieving such an object, an input device of the present disclosure includes a pair of electrodes for detecting coordinates arranged at an observer side of a display apparatus and facing each other to cross at right angles via a dielectric element. The display apparatus has a translucent substrate on a front substrate arranged at the observer side of a display panel. One of the electrodes for detecting coordinates is formed on the surface of the translucent substrate at the display panel side, the other electrode for detecting coordinates is formed on the front substrate of the display panel, and the translucent substrate is bonded onto the front substrate of the display panel via an adhesive serving as the dielectric element.

### Effects of the Invention

In the input device of the present invention, a pair of electrodes for detecting coordinates are formed respectively on a front substrate of a display panel and on a surface of a translucent substrate at the display panel side, arranged on the front substrate. Therefore, there is no necessity of adding any substrate or the like for the input device of the display apparatus, and thus it is possible to produce a display apparatus provided with an input device of a simple constitution. Furthermore, as one of the electrodes for detecting coordinates is formed on the translucent substrate, an electrode of a low resistance can be formed easily and thus it is possible to reduce the resistance value of the electrodes for detecting coordinates, and moreover, it can be manufactured using simple steps. Thereby, it can be applied easily to various display apparatuses.

### BRIEF DESCRIPTION OF DRAWINGS

FIG. 1 is a diagram for explaining a schematic constitution of a display apparatus provided with an input device of the present disclosure.

FIG. 2 is a cross-sectional view showing a constitution of a liquid crystal display apparatus provided with a touch panel as one embodiment of the input device of the present disclosure.

FIG. 3 is a plan view showing an example of an electrode pattern that constitutes a touch panel in a liquid crystal display apparatus provided with the touch panel as one embodiment of an input device of the present disclosure.

FIG. 4 includes sectional views showing steps for manufacturing a liquid crystal display apparatus comprising a touch panel as one embodiment of an input device of the present disclosure.

### DESCRIPTION OF THE INVENTION

The input device of the present invention is an input device arranged at the observer side of a display apparatus and is provided with a pair of electrodes for detecting coordinates facing each other to cross at right angles via a dielectric element. The display apparatus has a translucent substrate on the front substrate arranged at the observer side of the display panel. One of the electrodes for detecting coordinates is formed on the surface of the translucent substrate at the display panel side, while the other electrode for detecting coordinates is formed on the front substrate of the display panel. The translucent substrate is bonded onto the front substrate of the display panel via an adhesive serving as the dielectric element.

In the thus constituted input device of the present invention, one of the pair of electrodes for detecting coordinates constituting the input device, is formed on the surface of the translucent substrate at the display panel side arranged on the front substrate, while the other electrode for detecting coordinates is formed on the front substrate of the display panel, and the adhesive to bond the translucent substrate to the front substrate serves as the dielectric element. In this manner, since the input device is formed by use of a front substrate of a display panel, a translucent substrate arranged for example to protect the display panel, and an adhesive for adhesion, there is no necessity of newly including any substrate for the input device. Thus the constitution of a display apparatus provided with a touch-input function can be simplified. Furthermore, since one of the electrodes for detecting coordinates is formed on the translucent substrate manufactured in a step separate from that of the display panel, a high temperature process is applicable, the resistance value at the electrodes for detecting coordinates of the input device can be lowered, thereby improving the sensitivity of the touch panel and reducing the power consumption. Further, since the input device can be manufactured by a simple step of bonding, by means of an adhesive, a translucent substrate that has been manufactured in a step separately from the display panel, the process can be applied easily to various display apparatuses.

In the above-mentioned constitution, it is preferable that the display apparatus has a liquid crystal display panel as the display panel, and that the dielectric element is formed of the adhesive and a polarizer arranged on the front substrate of the liquid crystal display panel so as to cover the other electrode. Thereby, the polarizer to be used in the liquid crystal display panel can be utilized as the dielectric element of the input device.

Hereinafter, the input device according to the present disclosure will be described with reference to an example of a touch panel arranged at the observer side of a display panel for performing an image display, with reference to the attached drawings.

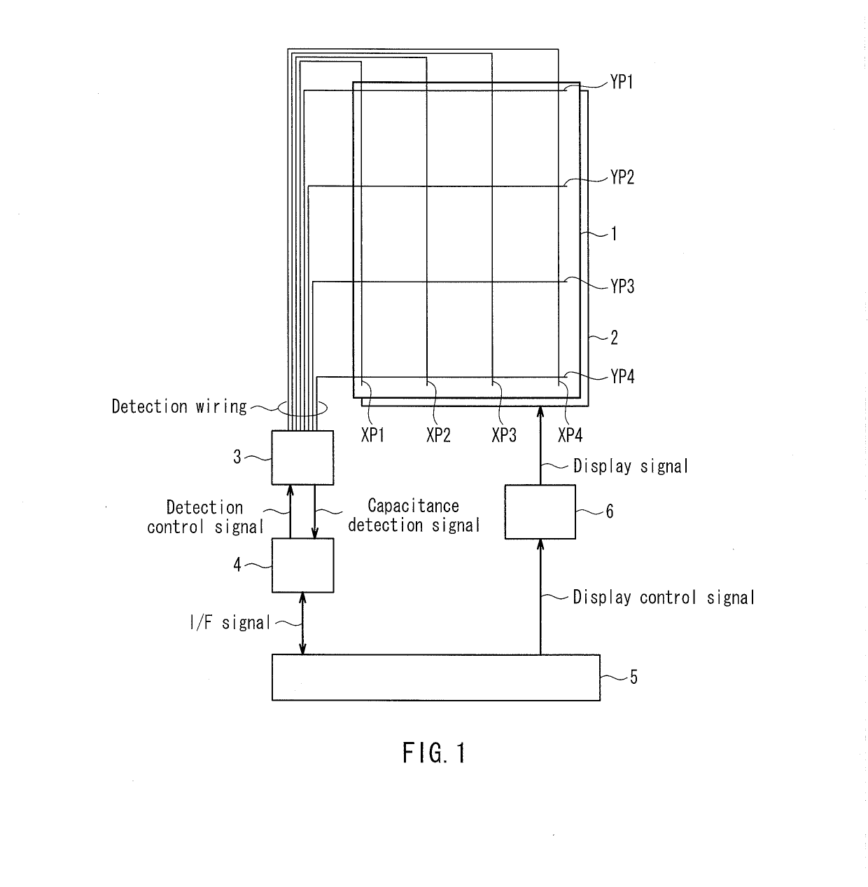

FIG. 1 is a diagram showing a schematic constitution of a display apparatus provided with a touch panel that will be explained in the present embodiment.

In FIG. 1, a capacitance coupling type touch panel 1 serving as an input device in the display apparatus is arranged on the front surface of a display panel 2, namely, at the side of an observer who monitors the display image. The touch panel 1 has a pair of electrodes for detecting coordinates, namely, (an) X electrode(s) XP for reception and (a) Y electrode(s) YP for transmission. A plurality of X electrodes XP and a plurality of Y electrodes YP are arranged respectively in parallel at a predetermined interval. Specifically, the X electrodes XP are oriented in the vertical direction and the Y electrodes YP are oriented in the horizontal direction on the image display surface of the display panel 2, and the X electrodes XP and the Y electrodes YP are arranged to cross each other at right angles. In FIG. 1, for convenience, four X electrodes of XP1 to XP4 and four Y electrodes of YP1 to YP4 are shown. In an actual touch panel 1, the numbers of the X electrodes and the Y electrodes are not limited to four. It is also possible to have different numbers for the X electrodes and the Y electrodes.

In the display apparatus, a user as the observer operates the touch panel 1 while observing the display image displayed on the display panel 2. Therefore, the display image of the display panel 2 should pass through the touch panel 1, and thus it is desirable that the touch panel 1 has a high transmissivity. For the display panel 2, a flat image display panel of various kinds, such as a liquid crystal display panel or an organic EL display panel can be used.

The X electrodes XP and the Y electrodes YP of the touch panel 1 are connected to a capacitance detection portion 3.

The capacitance detection portion 3 is controlled by a detection control signal outputted from a control calculation portion 4. Using the respective electrodes (X electrodes, Y electrodes) included in the touch panel 1, the capacitance detection portion 3 detects the change in the capacitance caused by the touches of the touch panel by the user. The capacitance detection portion 3 applies a predetermined voltage from the Y electrodes for transmission and detects changes in the charge by the X electrodes for reception, and outputs the changes in the charge at the X electrodes as a capacitance detection signal to the control calculation portion 4.

The control calculation portion 4 calculates data from the capacitance detection signal obtained from the change in the charge at the X electrodes, and it calculates the input coordinates of the touch position from the timing of transmission from the Y electrodes and the data at the X electrodes.

When the input coordinates are transferred from the control calculation portion 4 as a result of the touch operation, a control system 5 generates a display image according to the touch operation and transfers it as a display control signal to a display control circuit 6.

The display control circuit 6 generates a display signal for displaying the display image transferred as a display control signal from the control system 5 so as to display it on the display panel 2, and displays the image on the display panel 2.

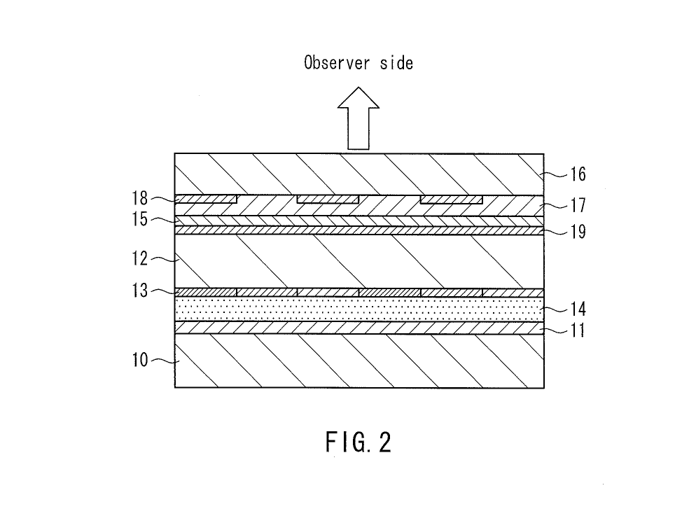

FIG. 2 is a cross-sectional view showing a constitution of a liquid crystal display apparatus comprising a touch panel according to the present embodiment and a liquid crystal display panel as a display panel. In FIG. 2, only the principal components arranged at the observer side of the liquid crystal display panel are shown. Components such as a backlight, which are arranged at the backside of the liquid crystal display panel for the purpose of displaying images on the liquid crystal display panel, namely, arranged oppositely to the observer side at which the touch panel is arranged, are not shown in FIG. 2.

In FIG. 2, on a translucent back substrate 10, a plurality of translucent pixel electrodes are formed in a matrix, and a plurality of thin film transistors (TFT) for switching on/off the application of the signal voltage to the respective pixel electrodes are formed. Thereby an active matrix type electrode portion 11 is formed.

On the inner surface of a translucent front substrate 12 arranged at the observer side to face the back substrate 10 with a spacing, a RGB color filter 13 is formed to correspond to the pixel electrodes formed on the back substrate 10, and a liquid crystal layer 14 is formed by filling the spacing between the back substrate 10 and the front substrate 12 with a liquid crystal. Further at the observer side of the front substrate 12, a polarizer 15 is arranged to pair up with a polarizer that is arranged at a further backside of the back substrate 10 and that is not shown in FIG. 2, thereby controlling the transmitted light of the liquid crystal layer 14. In this manner, the liquid crystal display panel 2 is constituted.

On the polarizer 15 of the liquid crystal display panel 2, a translucent substrate 16 to provide protection against breakage or the like of the liquid crystal display panel 2 is bonded via an adhesive 17 of a translucent polymer material. At the adhesive 17 side of this translucent substrate 16, a plurality of translucent transparent electrodes 18 constituting the X electrodes (for reception) of the electrodes for detecting coordinates of the touch panel are formed at a predetermined interval. Further, between the front substrate 12 and the outer polarizer 15 of the liquid crystal panel 2, a plurality of translucent transparent electrodes 19 that constitute the Y electrodes (for transmission) of the electrodes for detecting coordinates of the touch panel are formed at a predetermined interval. As a result of such constitution, between the transparent electrodes 18 and the transparent electrodes 19, a capacitance coupling is formed via a dielectric element defined by the polarizer 15 and the adhesive 17.

As a result, a capacitance coupling type touch panel 1 is formed of the translucent substrate 16 on which the transparent electrodes 18 are formed, the front substrate 12 of the liquid crystal panel 2 on which the transparent electrodes 19 are formed, and the polarizer 15 and the adhesive 17 arranged between these substrates. The above description refers to an example having a pair of electrodes constituting a capacitance coupling type touch panel, namely X electrodes for reception and Y electrodes for transmission. Alternatively, the Y electrodes may be used for reception and the X electrodes may be used for transmission.

Here, for the translucent substrate 16, a glass substrate of inorganic glass such as barium borosilicate glass and soda glass and chemical strengthening glass, or a resin substrate of high heat-resistant resin such as polyimide and Adamantate (trade mark) can be used.

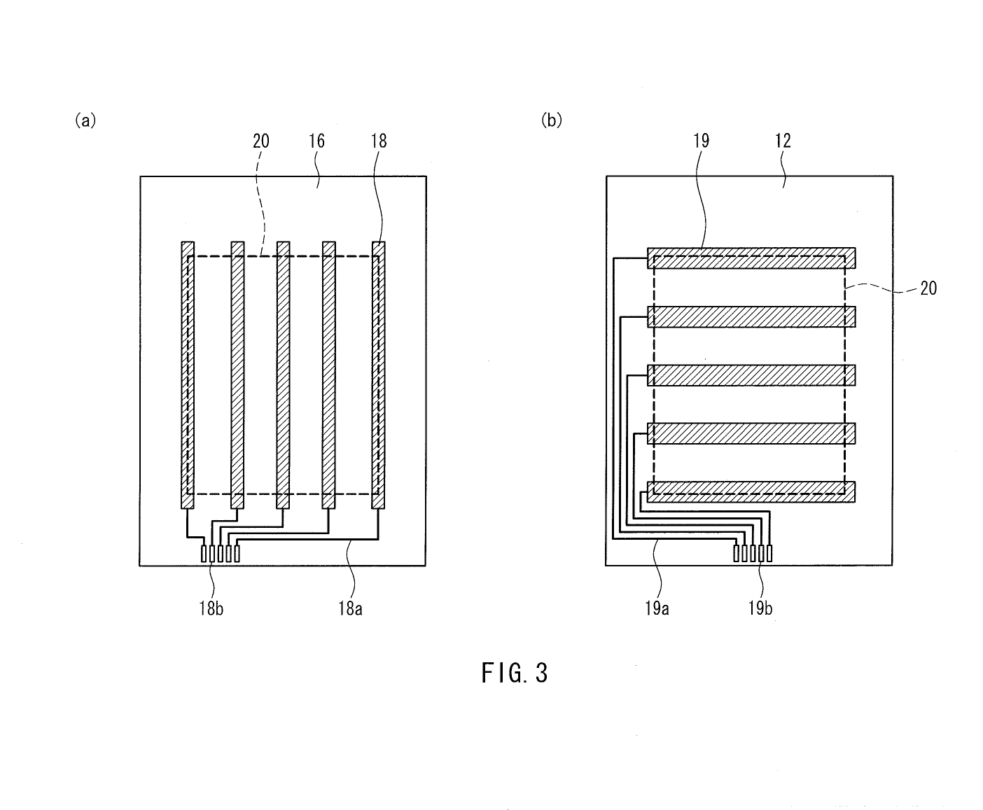

FIG. 3 is a plan view showing an example of an electrode pattern constituting a touch panel in a liquid crystal display apparatus comprising the touch panel as shown in FIG. 2. FIG. 3(a) shows transparent electrodes 18 as X electrodes provided on the translucent substrate 16 and FIG. 3(b) shows transparent electrodes 19 as Y electrodes provided on the front substrate 12 of the liquid crystal panel. In each of FIGS. 3(a) and 3(b), a region 20 expressed with a dotted line indicates a display region in the liquid crystal display panel.

As shown in FIGS. 3(a) and 3(b), traces 18a, 19a formed of a low-resistant metallic material such as silver or copper are connected to the respective transparent electrodes 18, 19 constituting the touch panel. The traces 18a, 19a are connected electrically to terminal portions 18b, 19b formed outside the display regions 20 at edges of the translucent substrate 16 and the front substrate 12.

Both of the transparent electrodes 18, 19 are constituted of conductive thin films having thickness of 50 to 200 Å for example. For the conductive thin films, ITO (indium tin oxide), ATO (antimony tin oxide), IZO (zinc tin oxide) or the like can be used. The transparent electrodes 18 are formed so that the sheet resistance will be about 40Ω/□ while the transparent electrodes 19 are formed so that the sheet resistance will be about 150Ω/□. Namely, the resistance value of the transparent electrodes 18 formed on the translucent substrate 16 at the user side is lower than the resistance value of the transparent electrodes 19 formed on the front substrate 12 at the liquid crystal display panel side.

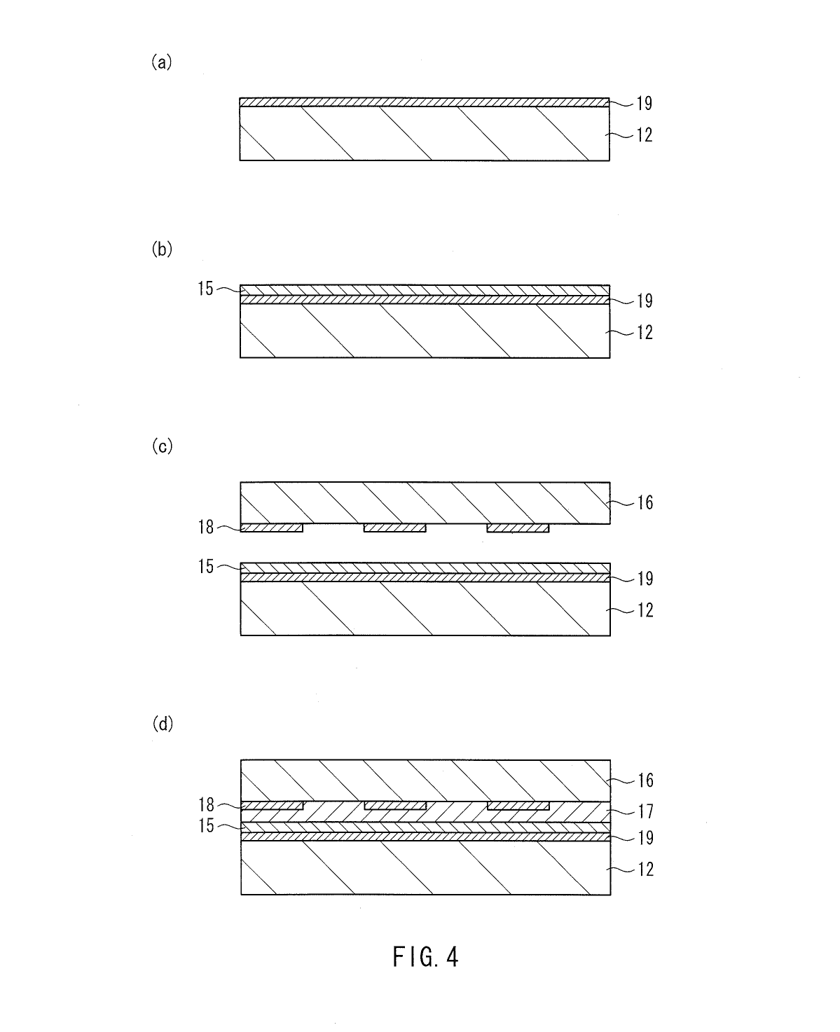

FIG. 4 shows the steps of manufacturing a liquid crystal display apparatus provided with the touch panel as shown in FIG. 2. Hereinafter, a method for manufacturing a liquid crystal display apparatus as a display apparatus according to the present embodiment will be explained with reference to FIG. 4.

First, similarly to the steps of manufacturing an ordinary liquid crystal display panel, a liquid crystal display panel is manufactured by injecting a liquid crystal between a front substrate and a back substrate constituting the liquid crystal display panel, and later, the back substrate 10 and the front substrate 12 of the liquid crystal display panel are etched chemically with hydrogen fluoride, thereby polishing the outer surfaces of the back substrate 10 (not shown) and the front substrate 12.

Later, as shown in FIG. 4(a), on the surface of the front substrate 12 of the liquid crystal panel, a transparent conductive thin film such as an ITO film is formed by sputtering, which is later patterned through a photolithography step. Thereby transparent electrodes 19 as Y electrodes shown in FIG. 3(b) are formed. At this time, since a liquid crystal has been injected into the liquid crystal display panel, a high-temperature process should not be used for the condition for forming the ITO film. As a result, for example, it is impossible to lower the sheet resistance of the ITO film formed at a temperature of 120° C. or lower. The sheet resistance of the thus formed ITO film is about 150Ω/□, for example.

Later, the traces 19a and the terminal portions 19b as shown in FIG. 3(b) are formed on the surface of the front panel 12, and a flexible wiring board for external connection is connected electrically to the terminal portions 19b with an anisotropic conductive adhesive or the like.

Later, as shown in FIG. 4(b), a polarizer 15 is bonded to the front substrate 12 over the transparent electrodes 19.

In the meantime, the transparent electrodes 18 are formed on the translucent substrate 16 in a separate step. In this step, on the surface of the translucent substrate 16 of a glass substrate, a transparent conductive thin film such as an ITO film is formed by sputtering and then patterned in a photolithography step. Thereby, the transparent electrodes 18 as X electrodes as shown in FIG. 3(a) are formed. Later, the traces 18a and the terminal portions 18b shown in FIG. 3(a) are formed on the translucent substrate 16, and a flexible wiring board for external connection is connected electrically to the terminal portions 18b by an anisotropic conductive adhesive or the like. At this time, since it is possible to form the ITO film at a high temperature of about 200° C. or higher, the sheet resistance value of the ITO film can be lowered without increasing the thickness of the ITO film. The sheet resistance of the thus formed ITO film is about 40Ω/□ for example.

Later, as shown in FIG. 4(c), the translucent substrate 16 having the transparent electrodes 18 manufactured in a separate step is aligned with respect to the liquid crystal display panel on which the transparent electrodes 19 and the polarizer 15 have been disposed, and then as shown in FIG. 4(d), the liquid crystal display panel and the translucent substrate are bonded to each other with the translucent adhesive 17. Thereby, a liquid crystal display apparatus having a touch panel can be provided as a finished product.

Alternatively, the adhesive 17 used for bonding the liquid crystal display panel and the translucent substrate may be formed by application of a liquid adhesive, or may be formed by bonding a sheet-like adhesive. Alternatively, after forming the adhesive 17 on the liquid crystal display panel at the polarizer 15 side, the translucent substrate 16 with the transparent electrodes 18 formed thereon may be bonded onto this adhesive 17. In an alternative process, the adhesive 17 is formed in advance on the translucent substrate 16 with the transparent electrodes 18 formed thereon, and later, the translucent substrate 16 on which the adhesive 17 is formed may be bonded onto the polarizer 15 of the liquid crystal display panel.

As mentioned above, in the input device according to the present embodiment, the transparent electrodes 19 as one part of the electrodes for detecting coordinates of the input device are formed on the surface of the front substrate 12 that is one of the substrates constituting the liquid crystal display panel as the display panel and that is arranged at the observer side. The transparent electrodes 18 as the other part of the electrodes for detecting coordinates are formed on the surface of the translucent substrate 16 that is provided at the liquid crystal display panel side for the purpose of protection of the liquid crystal display panel. The polarizer 15 arranged to cover the transparent electrodes 19 and the adhesive 17 to bond the translucent substrate 16 acts as the dielectric elements arranged between the pairs of the electrodes for detecting coordinates.

Accordingly, the touch panel as an input device of the present embodiment is prepared by forming electrodes for detecting coordinates both on the front substrate 12 of the display panel and on the translucent substrate 16 that is arranged at the observer side of the display panel for the purpose of e.g., protection of the display panel. In the touch panel, the adhesive 17 for bonding the translucent substrate and the polarizer 15 necessary for image display on the liquid crystal display panel are utilized as the dielectric elements. By using the thus constituted liquid crystal display panel, there is no necessity of newly adding any substrate for an input device, and thus the constitution of the display panel can be simplified. Furthermore, by arranging one part of electrodes of the touch panel on a surface of the translucent substrate 16 facing the front substrate 12 of the liquid crystal display panel, the transparent electrodes 18 as the electrodes for detecting coordinates at the translucent substrate 16 side can be manufactured in a step separate from the step for manufacturing the liquid crystal display panel. Therefore, a process at high temperature can be employed to form easily a low resistance electrode, and thus it is possible to lower the resistance value of the electrodes for detecting coordinates of the input device. As a result, it is possible to improve the sensitivity of the touch panel and reduce power consumption in the input device according to the present embodiment.

Further, since the input device of the present disclosure can be manufactured by a simple step of bonding with an adhesive a translucent substrate produced in a process separate from the process of manufacturing the display panel, it can be applied easily to a display apparatus that uses as a display panel an organic EL display panel that is other that the liquid crystal display panel explained in the above embodiment and to which a high temperature process should not be applied.

In a case where an organic EL panel is used for the display panel, a back substrate formed of a driving circuit of TFT and an organic layer of the organic EL panel corresponds to the back substrate of the liquid crystal panel explained in the above embodiment. And, a sealing glass substrate formed to prevent deterioration of the organic layer due to moisture or oxygen in the organic EL panel corresponds to the front substrate of the liquid crystal panel.

In a case of using an organic EL for a display panel, unlike the liquid crystal panel explained in the above embodiment, no polarizer is arranged outside the front substrate. In such a case, the dielectric element of the input device is formed of an adhesive that bonds the translucent substrate formed on the front substrate of the organic EL panel.

### INDUSTRIAL APPLICABILITY

As mentioned above, the input device of the present disclosure is available to various applications as a capacitance coupling type input device.

1. An input device comprising a pair of electrodes for detecting coordinates arranged at an observer side of a display apparatus and facing each other to cross at right angles via a dielectric element, wherein
the display apparatus has a translucent substrate on a front substrate arranged at the observer side of a display panel, one of the electrodes for detecting coordinates is formed on the surface of the translucent substrate at the display panel side, the other electrode for detecting coordinates is formed on the front substrate of the display panel, and the translucent substrate is bonded onto the front substrate of the display panel via an adhesive serving as the dielectric element, and
the one of the electrodes for detecting coordinates has a sheet resistance value lower than a sheet resistance value of the other electrode for detecting coordinates.

2. The input device according to claim 1, wherein the display apparatus comprises as the display panel a liquid crystal display panel, and a polarizer and the adhesive arranged to cover the other electrode on the front substrate of the liquid crystal display panel form the dielectric element.

3. The input device according to claim 1, wherein the display apparatus comprises an organic EL display panel as the display panel, and the adhesive on the front substrate of the organic EL display panel forms the dielectric element.
